(19) United States
(12) Patent Application Publication
(10) Pub. No.: US 2015/0050385 A1
(43) Pub. Date: Feb. 19, 2015

(54) QUARK BASE MIX HAVING ENHANCED TASTE PROPERTIES II

(71) Applicant: DMK Deutsches Milchkontor GmbH, Zeven (DE)

(72) Inventors: Marina Schomacker, Sittensen (DE); Michael Hahn, Heerlingen (DE)

(21) Appl. No.: 14/459,560

(22) Filed: Aug. 14, 2014

(30) Foreign Application Priority Data
Aug. 18, 2013 (EP) 13 180 795.0

(51) Int. Cl. A23C 9/127

(52) U.S. Cl. CPC A23C 9/127
USPC 426/43; 426/61

(57) ABSTRACT

A quark base mix is proposed having enhanced taste properties, which is obtainable in that
(a) raw milk is subjected to a temperature treatment and the cream is separated off in such a manner that a non-acidified quark base mix is formed,
(b) the resultant mixture is subjected to a temperature treatment until denaturation occurs,
(c) the denatured product is admixed with starter cultures and rennet and optionally
(d) the quark base mix obtained after completion of fermentation is adjusted to a defined dry matter content and protein content,
   and, as starter culture,
(i) a first mixture of five microorganisms comprising (i-1) Streptococcus thermophilus, (i-2) Leuconostoc species, (i-3) Lactococcus lactis subsp. lactis biovar diacetylactis, (i-4) Lactococcus lactis subsp. lactis and (i-5) Lactococcus lactis subsp. cremoris, and
(ii) a second mixture of three microorganisms comprising (ii-1) Streptococcus thermophilus, (ii-2) Lactococcus lactis subsp. lactis and (ii-3) Lactococcus lactis subsp. cremoris
   are used.

### FIELD OF THE INVENTION

The invention is in the field of milk products and relates to a quark with enhanced taste and also to a method for production thereof.

### PRIOR ART

To produce quark, generally, skimmed milk is subjected to a temperature treatment and the proteins therein are denatured.

The subsequent addition of lactic acid bacteria and rennet performs what is termed coagulation (phase reversal) of milk. The casein coagulates and forms what is termed coagulum in the art. After ripening (8 to 20 h), the coagulum is agitated. The whey separation is initiated thereby, and the two phases are then separated in the separator. The liquid acid whey is processed in other ways and the quark base mix is adjusted to the desired fat and protein contents by adding cream.

However, these methods of the prior art have the disadvantage that the sensory assessment of the quark is assessed as unsatisfactory by many consumers. Either the product is faultless with respect to taste, but has a rough structure or, from the haptic impression, it is creamy, but leaves behind a slimy overall impression.

On the market, in addition, there is a great requirement for ready-to-eat quark preparations which have a fresh fruit topping—whether this be in the form of a puree or a salad containing pieces of fruit. Such products must be prepared until now in each case freshly before consumption. In this case, the problem is not so much to maintain in the fresh state and preserve the fruit-containing quark preparations in the packaged state. It is considerably more problematic that the fruits draw water and the fruit juice migrates through the product, dilutes it, and as a result adversely affects the eating properties.

The complex object of the present invention was therefore to provide a quark mix having enhanced taste properties, which, on consumption, leaves behind directly a creamy impression, without the product tasting slimy. In addition, the quark mix should have a quality such that it can be charged with a fresh fruit preparation without the fruit juice diluting the quark mix.

### DESCRIPTION OF THE INVENTION

A first subject matter of the invention relates to a quark base mix having enhanced taste properties, obtainable in that
(a) raw milk is subjected to a temperature treatment and the cream is separated off in such a manner that a non-acidified quark base mix is formed,
(b) the resultant mixture is subjected to a temperature treatment until denaturation occurs,
(c) the denatured product is admixed with starter cultures and rennet and optionally
(d) the quark base mix obtained after completion of fermentation is adjusted to a defined dry matter content and protein content,
   and, as starter culture,
(i) a first mixture of five microorganisms comprising (i-1) Streptococcus thermophilus, (i-2) Leuconostoc species, (i-3) Lactococcus lactis subsp. lactis biovar diacetylactis, (i-4) Lactococcus lactis subsp. lactis and (i-5) Lactococcus lactis subsp. cremoris, and
(ii) a second mixture of three microorganisms comprising (ii-1) Streptococcus thermophilus, (ii-2) Lactococcus lactis subsp. lactis and (ii-3) Lactococcus lactis subsp. cremoris
   are used.

Preferably, the quark base mix according to the invention has, at 20° C., a Brookfield viscosity (RVT, spindle 1, 10 rpm) in the range from about 1000 to about 8000 mPas, preferably about 2000 to about 6000 mPas and in particular about 3000 to about 5000 mPas.

A second subject matter of the invention relates to a ready-to-eat quark preparation which contains the above described base mix and also a topping, for example made of a fresh fruit preparation. This fruit preparation can be, for example, a fruit puree or fruit salad. Alternatively, comminuted nuts, chocolate pieces or sauces can also be used as what are termed “toppings”.

A third subject matter of the invention is directed towards a method for producing a quark base mix having enhanced taste properties, in which
(a) raw milk is subjected to a temperature treatment and the cream is separated off, in such a manner that a non-acidified quark base mix is formed,
(b) the resultant mixture is subjected to a temperature treatment until denaturation occurs,
(c) the denatured product is admixed with starter cultures and rennet and optionally
(d) the quark base mix obtained after completion of fermentation is adjusted to a defined dry matter content and protein content,
   wherein, as starter culture,
(i) a first mixture of five microorganisms comprising (i-1) Streptococcus thermophilus, (i-2) Leuconostoc species, (i-3) Lactococcus lactis subsp. lactis biovar diacetylactis, (i-4) Lactococcus lactis subsp. lactis and (i-5) Lactococcus lactis subsp. cremoris, and
(ii) a second mixture of three microorganisms comprising (ii-1) Streptococcus thermophilus, (ii-2) Lactococcus lactis subsp. lactis and (ii-3) Lactococcus lactis subsp. cremoris
   are used.

Surprisingly, it has been found that when the selected starter cultures are used, a quark that is significantly enhanced in taste is obtained which tastes creamy and does not leave behind a slimy overall impression. When a special rotor-stator technique is used in the mixing or after treatment of the products, the creaminess can be further significantly enhanced. In addition, this measure produces a consistency which, although it does not fully prevent the penetration of fruit juice from a fruit topping, it does however considerably delay it. In this manner, for the first time, even ready-to-eat quark preparations having a fresh fruit topping may be produced on an industrial scale. In this manner, the quark base mix, the ready-to-eat quark preparation and the associated production method are linked by a common inventive concept.

### Production of the Non-Acidified Quark Base Mix

To produce the non-acidified quark base mix, solid components are initially separated off, and also the fat fraction of about 4% by weight is skimmed from the raw milk. This usually takes place in a special unit, preferably a separator. Such units are sufficiently known from the prior art. Separators from GEA Westfalia Separator GmbH are very widespread in the milk industry, and with which the two steps can be carried out individually or together.¹ Corresponding units are also described, for example, in DE 10036085 C1 (Westfalia) and are very well known to those skilled in the art, and thus for carrying out these method steps, no explanations are required, since they are considered part of general specialist knowledge. ¹(http://www.westfalia-separator.com/de/anwendungen/molkereitechnik/milch-molke.html).

The raw milk is preferably heat-treated in heat exchangers, wherein special plate heat exchangers have proved to be particularly suitable. There is a temperature gradient on the heat exchangers which, however, is selected in such a manner that the raw milk is heated for a residence time of at least 20 seconds and at most 60 seconds, preferably about 30 seconds, to a temperature of from about 70 to 80° C. and in particular about 72 to 74° C.

### Denaturation

In the following step, the resultant non-acidified quark base mix is subjected to a thermal treatment. The denaturation then proceeding can proceed in a manner known per se, namely over a period of about 5 to about 10 min, and preferably about 6 min, and at temperatures of from about 85 to about 90° C., and in particular about 88° C.

### Fermentation and Standardization

The fermentation of the denatured preliminary product can also proceed according to the known methods of the prior art. For this purpose, suitable starter cultures and rennet are added.

Preferably, the starter cultures contain
about 10 to about 90% by weight, preferably about 25 to about 75% by weight, and in particular about 40 to about 60% by weight of the mixture (i) and
about 90 to about 10% by weight, preferably about 75 to about 25% by weight, and in particular about 60 to about 40% by weight of the mixture (ii)
   with the proviso that the quantities total 100% by weight.

Particular preference is given to starter cultures which contain
about 40 to about 60% by weight of the mixture (i) and
about 60 to about 40% by weight of the mixture (ii)
   with the proviso that the quantities total 100% by weight.

In a further preferred embodiment, the five microorganisms which form the mixture (i) and also the three microorganisms which form the mixture (ii) are present in each case at about equal amounts. “About equal” in this context is taken to mean that in the mixture (i), the five microorganisms are each present in amounts of 20±5% by weight and in the mixture (ii), the three microorganisms are each present in amounts of 33±5% by weight.

Instead of using the two commercially available preparations (i) and (ii) together, it is, of course, in principle also possible to use the five microorganisms individually and then to mix them in such a manner that a starter culture mixture is obtained, with which the enhanced taste quark products are obtained. Such starter cultures then contain, preferably
about 20 to about 30% by weight Streptococcus thermophilus,
about 5 to about 15% by weight Leuconostoc species,
about 5 to about 10% by weight Lactococcus lactis subsp. lactis biovar diacetylactis,
about 20 to about 30% by weight Lactococcus lactis subsp. lactis,
about 20 to about 30% by weight Lactococcus lactis subsp. cremoris, and
   with the proviso that the quantities total 100% by weight.

Particular preference is given to starter cultures containing
25% by weight Streptococcus thermophilus,
12% by weight Leuconostoc species,
13% by weight Lactococcus lactis subsp. lactis biovar diacetylactis,
25% by weight Lactococcus lactis subsp. lactis,
25% by weight Lactococcus lactis subsp. cremoris.

All stated microorganisms are freely available commercially.

The temperature at which the fermentation takes place depends on the temperature range which is optimum for the microorganisms respectively used; typically, the temperature is in the range from about 18 to about 35° C., and preferably at about 30° C.

The fermented milk products can exhibit quality variations owing to differing influences in the production method. The initiators such as, for example, temperature variations, pH changes, mechanical shocks and the like are usually unavoidable. The result is a rough structure (“stipple”), syneresis, viscosity variations and the like. In order to avoid this, in a further preferred embodiment of the invention, shear energy is introduced into the fermented mix.

This can be performed, for example, by stirring the mixture smooth in the tank, which occasionally leads to a decrease in viscosity and therefore is not especially preferred. Frequently, in this case, air is also introduced, which leads to oxidation processes and a faulty taste.

Alternatively, what are termed smoothing valves can also be used. In this case, although the roughness in the product is reduced, here also, the viscosity can decrease and in addition there is the risk that, in particular, towards the end of the process, owing to pressure variations, stipples pass through which then may be found in the end product. In a further embodiment, screens can also be used which, however, is frequently at the cost of creaminess. In addition, screens are difficult to keep clean.

Therefore, in the context of the present invention, it has proved to be particularly advantageous to further improve the creaminess of the product by introducing a defined amount of gravity energy via at least one rotor-stator mixer; this method is also termed “stretching”. In this case, depending on requirements, one to three-stage systems are used. By variation of slot width, number and geometry of tooth rows, number of rotor-stator sets, residence time and speed of rotation, the desired viscosity and creaminess can be set in each case, wherein the adjustment of these parameters by an expert person can be performed on the basis of his general knowledge, without needing to exercise inventive skill for this. Corresponding units are commercially available, for example, under the name “Ytron-Z” (Ytron mixers) from Ytron Process Technology GmbH.

The quark base mix obtained after the fermentation and optionally after the stretching is then adjusted to the desired content of dry matter and proteins, for example by adding cream. Preferably, the dry matter content is about 15 to about 20% by weight, and in particular about 18% by weight. The protein content can be about 10 to about 15% by weight, and preferably about 12% by weight.

### EXAMPLES

### Examples 1 to 4, Comparative Examples C1 to C5

4 kg of skimmed milk were treated at 88° C. for 6 min and the resultant proteins were denatured. The mix was admixed with lactic acid bacteria and rennet and ripened at about 30° C. for about 18 h and then agitated. The fermentation product was then placed in a centrifuge and approximately 3.2 kg of acid whey were separated off as a liquid component. The remaining quark mix (approximately 800 g) was adjusted to a dry matter of 18% by weight and a protein content of 12% by weight by addition of cream. Example 4 differs from Example 2 in that the base mix was additionally stirred (“stretched”) after the fermentation in a rotor-stator mixer from YTRON. Then, the producers were evaluated for taste and sensory properties on a scale from 1 (=does not apply) to 6 (=applies fully) by a panel consisting of 5 experienced testers. The results are summarized in Table 1. Examples 1 to 4 are according to the invention, Examples C1 to C5 serve for comparison. The mean values of the evaluations are stated.

TABLE 1
Taste and sensory assessment of the quark base mixes

| | | Taste | Sensory quality | | |
|---|---|---|---|---|---|
| Ex. | Starter culture | Bitter | Creamy | Smooth | Slimy |
| C1 | Bifidobacterium lactis B12 | 5.5 | 3.0 | 2.0 | 5.5 |
| C2 | Lactobacillus acidophilus | 5.0 | 3.5 | 2.0 | 5.5 |
| C3 | Bifidobacterium lactis B12 + | 5.0 | 3.0 | 2.0 | 5.5 |
| | Lactobacillus acidophilus | | | | |
| | (1:1) | | | | |
| C4 | Mixture (i) | 3.0 | 2.5 | 2.0 | 4.0 |
| C5 | Mixture (i) | 4.0 | 2.0 | 2.0 | 4.0 |
| 1 | Mixture (i + ii) = 75:25 | 2.0 | 4.0 | 3.5 | 2.0 |
| 2 | Mixture (i + ii) = 50:50 | 1.5 | 4.5 | 4.0 | 1.0 |
| 3 | Mixture (i + ii) = 25:75 | 2.5 | 4.0 | 3.5 | 1.5 |
| 4 | Mixture (i + ii) = 50:50 | 1.0 | 5.5 | 4.5 | 1.0 |

The experiments and comparative experiments clearly show that the selection of the starter cultures has a considerable influence on the taste and sensory properties of the quark base mix. The quark base mix having the best properties, i.e. the lowest bitterness, the highest creaminess, which in addition did not leave behind a slimy impression, was achieved using a combination according to the invention of the culture mixtures (i) and (ii). Treatment in the Ytron mixer further enhanced the sensory values.

### Examples 5 to 7, Comparative Examples C6 to C10

The following examples show the effect which the targeted introduction of stirring energy into the fermented quark base mix has on the physicochemical behaviour thereof. An assessment was made as to the effect of the treatment on the tendency of the quark base mix to take up water on addition of fruit preparations and thus become diluted in taste. For this purpose, quark base mixes according to the invention which were produced on the basis of different starter cultures were coated once before and once after treatment with a rotor-stator mixer from YTRON (20° C., 15 min, 2500 rpm) with in each case 25% by weight of a sweetened preparation of fruit pieces of strawberries and pineapples, and both optical and also taste impressions were assessed by a panel of 5 experienced testers after storage of the preparations for a period of 5 hours at 7° C.

The optical assessment was made on the basis of a scale from (1)=clear separation between quark mix and fruit preparation and (4)=quark mix and fruit preparation mixed; the taste assessment was performed in a similar manner on a scale from (1)=pronounced fruit taste to (4)=watery taste.

The results are summarized in Table 2 below. Examples 5 to 7 are according to the invention, Examples C6 to C10 serve for comparison.

TABLE 2
Assessment of the quark base mixes without and
with aftertreatment with a rotor-stator mixer

| | | Optical | | Taste | |
|---|---|---|---|---|---|
| | | impression | | impression | |
| Ex. | Starter culture | without | with | without | with |
| C6 | Bifidobacterium lactis B12 | 3.5 | 3.0 | 3.0 | 2.5 |
| C7 | Lactobacillus acidophilus | 3.5 | 3.0 | 3.0 | 3.0 |
| C8 | Bifidobacterium lactis B12 + | 3.5 | 3.0 | 3.0 | 2.5 |
| | Lactobacillus acidophilus | | | | |
| | (1:1) | | | | |
| C9 | Mixture (i) | 3.0 | 3.0 | 3.0 | 2.5 |
| C10 | Mixture (i) | 3.0 | 2.5 | 3.0 | 2.5 |
| 5 | Mixture (i + ii) = 75:25 | 2.0 | 1.0 | 2.0 | 1.0 |
| 6 | Mixture (i + ii) = 50:50 | 1.5 | 1.0 | 1.5 | 1.0 |
| 7 | Mixture (i + ii) = 25:75 | 2.0 | 1.0 | 2.0 | 1.0 |

The examples and comparative examples show that as a result of the after treatment in the rotor-stator mixer, both the optical impression and the taste impression are further substantially enhanced. In this case, the use of selected culture mixtures, in comparison with the standard product bifidobacterium, again leads to a markedly better end product.

1. A quark base composition having enhanced taste properties, obtainable in that
(a) raw milk is subjected to a temperature treatment and the cream is separated off in such a manner that a non-acidified quark base mix is formed,
(b) the resultant mixture is subjected to a temperature treatment until denaturation occurs,
(c) the denatured product is admixed with starter cultures and rennet and optionally
(d) the quark base mix obtained after completion of fermentation is adjusted to a defined dry matter content and protein content,
and, as starter culture,
(i) a first mixture of five microorganisms comprising (i-1) Streptococcus thermophilus, (i-2) Leuconostoc species, (i-3) Lactococcus lactis subsp. lactis biovar diacetylactis, (i-4) Lactococcus lactis subsp. lactis and (i-5) Lactococcus lactis subsp. cremoris, and
(ii) a second mixture of three microorganisms comprising (ii-1) Streptococcus thermophilus, Lactococcus lactis subsp. lactis and (ii-3) Lactococcus lactis subsp. cremoris
are used.

2. The composition of claim 1, wherein said mix contains the mixtures of the starter cultures in the weight ratio (i):(ii) of from about 10:90 to about 90:10.

3. The composition of claim 1, containing the mixtures of the starter cultures in the weight ratio (i):(ii) of from about 40:60 to about 60:40.

4. The composition of claim 1, containing the five microorganisms which form the mixture (a) and the three microorganisms which form the mixtures (b) in respectively approximately equal amounts.

5. A Ready-to-eat quark preparation containing the base mix according to claim 1 and also a topping made of a fruit preparation.

6. The preparation of claim 5, wherein said fruit preparation is a fruit puree or fruit salad.

7. A method for producing the composition of claim 1, comprising the following steps:
(a) subjecting raw milk to a temperature treatment and separating the cream off, in such a manner that a non-acidified quark base mix is formed;
(b) subjecting the resultant mixture to a temperature treatment until denaturation occurs,
(c) mixing the denatured product with starter cultures and rennet, and optionally
(d) adjusting the quark base mix obtained after completion of fermentation to a defined dry matter content and protein content,
wherein said starter culture represents a blend of
(i) the first mixture of five microorganisms comprising (i-1) Streptococcus thermophilus, (i-2) Leuconostoc species, (i-3) Lactococcus lactis subsp. lactis biovar diacetylactis, (i-4) Lactococcus lactis subsp. lactis and (i-5) Lactococcus lactis subsp. cremoris, and
(ii) the second mixture of three microorganisms comprising (ii-1) Streptococcus thermophilus, (ii-2) Lactococcus lactis subsp. lactis and (ii-3) Lactococcus lactis subsp. Cremoris.

8. The method of claim 7, wherein the blends of the starter cultures contain the mixtures (i) and (ii) in a weight ratio of from about 10:90 to about 90:10.

9. The method of claim 7, wherein the blends of the starter cultures contain the mixtures (i) and (ii) in a weight ratio of from about 40:60 to about 60:40.

10. The method of claim 7, wherein the five microorganisms which form the mixture (a), and the three microorganisms which form the mixtures (b), are present in each case in approximately equal amounts.

11. The method of claim 7 wherein the non-acidified quark base mix is subjected to a temperature treatment of 85 to 90° C. over a period of 5 to 10 min and denatured in the course of this.

12. The method of claim 7, wherein the resultant denatured mix is admixed with cultures and rennet at 18 to 35° C.

13. The method of claim 7, wherein the quark base mix is subjected to an after-treatment in which shear energy is introduced.

14. The method of claim 13, wherein the shear energy is introduced via at least one rotor-stator mixer.
